(19) United States
(12) Patent Application Publication
(10) Pub. No.: US 2026/0366960 A1
(43) Pub. Date: Nov. 19, 2026

(54) Light Vehicle Dynamometer

(71) Applicant: SEA, LTD., COLUMBUS, OH (US)

(72) Inventors: Dale Andreatta, Columbus, OH (US); Austin Kress, Columbus, OH (US); Scott Zagorski, Delaware, OH (US); Meredith Bartholomew, Hilliard, OH (US); Austin Bowers, Grove City, OH (US); Gary Heydinger, Grandview Heights, OH (US)

(21) Appl. No.: 19/577,719

(22) Filed: Mar. 25, 2026

Related U.S. Application Data
(60) Provisional application No. 63/777,205, filed on Mar. 25, 2025.

(51) Int. Cl. G01M 17/007; G01L 3/18

(52) U.S. Cl. CPC G01M 17/0074; G01L 3/18; G01M 17/0076

(57) ABSTRACT

A dynamometer is provided herein. The dynamometer is adapted for use with an associated vehicle. The dynamometer can be modular, and multiple modular dynamometers can be provided to form a system. The dynamometer includes a roller assembly having at least one roller configured to interface with one or more corresponding wheels of the associated vehicle. The dynamometer can include a flywheel assembly, a brake, a sensor, and a drive shaft. The dynamometer can include a vertical spar and a horizontal spar with a carriage configured to interface with a component of the associated vehicle to simulate a rider weight on the associated vehicle by applying a load to the component. The dynamometer can include a rider interface component, such as a tilt actuator, a pedal control assembly, and a throttle control assembly.

### CROSS-REFERENCE TO RELATED APPLICATIONS

This application claims the benefit under 35 U.S.C. § 119(e) of U.S. Provisional Patent Application No. 63/777,205 filed Mar. 25, 2025, the content of which is incorporated by reference herein in its entirety.

### FIELD

The disclosure is directed to a dynamometer for use with an associated vehicle.

### BACKGROUND

Conventional dynamometers do not provide suitable modularity and control for use with light vehicles such as all-terrain vehicles, off-road vehicles, side-by-side vehicles, electric scooters, electric skateboards, electric bicycles, electric unicycles, hoverboards, segways, unmanned product delivery vehicles, and the like. For example, conventional dynamometers are not adapted to be modular to adapt to various sizes, shapes, or configurations of vehicles to be tested and do not provide adequate control for key parameter measurements, properly simulate inputs or loads, or otherwise interface with key rider interface components of a vehicle.

As such, it would be desirable to provide a dynamometer for use with an associated vehicle (e.g., an all-terrain vehicle, an off-road vehicle, a side-by-side vehicle, an electric scooter, an electric skateboard, an electric bicycle, an electric unicycle, a hoverboard, a segway, an unmanned product delivery vehicle, a snowmobile) that is modular (e.g., can be adjusted or otherwise adapted to various sizes, shapes, or configurations of vehicles, can be used with one or more other modular dynamometers to form a dynamometer system) or is otherwise adapted to provide adequate control for key parameter measurements (e.g., torque, distance traveled, speed, power, assistance amount, voltage, current, temperature), properly simulate inputs or loads (e.g., rider weight, parasitic loads), or otherwise interface with key rider interface components (e.g., pedal, throttle) of a vehicle.

### BRIEF SUMMARY

In a first aspect, a modular dynamometer for use with an associated vehicle is provided. The dynamometer comprises: a roller assembly comprising at least one roller configured to interface with one or more corresponding wheels of the associated vehicle; a flywheel assembly operatively connected to the roller assembly and configured to simulate an inertial load on the associated vehicle via the at least one roller of the roller assembly; a brake operatively connected to the roller assembly and configured to simulate a parasitic load for the associated vehicle via the at least one roller of the roller assembly; a drive shaft extending between and interconnecting the at least one roller of the roller assembly and the flywheel assembly; and a sensor disposed between the roller assembly and the brake and operatively connected to the at least one roller of the roller assembly.

In a second aspect, another modular dynamometer for use with an associated vehicle is provided. The dynamometer comprises: a roller assembly comprising at least one roller configured to interface with one or more corresponding wheels of the associated vehicle; a vertical spar extending upwardly relative to the roller assembly along a first axis; and a horizontal spar attached to and extending outwardly away from the vertical spar, the horizontal spar comprising a carriage configured to interface with a component of the associated vehicle to simulate a rider weight on the associated vehicle by applying a load to the component of the associated vehicle.

In a third aspect, a modular dynamometer system for use with an associated vehicle is provided. The modular dynamometer system comprises a first modular dynamometer and a second modular dynamometer configured to be selectively positionable relative to one another. Each of the first and second dynamometers comprises: a roller assembly comprising at least one roller configured to interface with one or more corresponding wheels of the associated vehicle; a flywheel assembly operatively connected to the roller assembly and configured to simulate an inertial load on the associated vehicle via the at least one roller of the roller assembly; a brake operatively connected to the roller assembly and configured to simulate a parasitic load for the associated vehicle via the at least one roller of the roller assembly; a drive shaft extending between and interconnecting the at least one roller of the roller assembly and the flywheel assembly; and a sensor disposed between the roller assembly and the brake and operatively connected to the at least one roller of the roller assembly.

In a fourth aspect, a dynamometer for use with an associated vehicle is provided. The dynamometer comprises: a roller assembly comprising at least one roller configured to interface with one or more corresponding wheels of the associated vehicle; a vertical spar extending upwardly relative to the roller assembly along a first axis; and a horizontal spar attached to and extending outwardly away from the vertical spar, the horizontal spar comprising a carriage configured to interface with a component of the associated vehicle to simulate a rider weight on the associated vehicle by applying a load to the component of the associated vehicle, wherein the horizontal spar is configured to slide along at least a portion of the vertical spar along the first axis to selectively position the horizontal spar at a height corresponding to the component of the associated vehicle.

In a fifth aspect, another dynamometer for use with an associated vehicle is provided. The dynamometer comprises: a roller assembly comprising at least one roller configured to interface with one or more corresponding wheels of the associated vehicle; a vertical spar extending upwardly relative to the roller assembly along a first axis; and a horizontal spar attached to and extending outwardly away from the vertical spar, the horizontal spar comprising a carriage configured to interface with a component of the associated vehicle to simulate a rider weight on the associated vehicle by applying a load to the component of the associated vehicle, wherein the carriage is configured to slide along at least a portion of the horizontal spar along a second axis substantially perpendicular to the first axis to selectively position the carriage at a location corresponding to the component of the associated vehicle.

In a sixth aspect, another dynamometer for use with an associated vehicle is provided. The dynamometer comprises: a roller assembly comprising at least one roller configured to interface with one or more corresponding wheels of the associated vehicle; a vertical spar extending upwardly relative to the roller assembly along a first axis; and a horizontal spar attached to and extending outwardly away from the vertical spar, the horizontal spar comprising a carriage configured to interface with a component of the associated vehicle to simulate a rider weight on the associated vehicle by applying a load to the component of the associated vehicle, wherein the horizontal spar is configured to slide along at least a portion of the vertical spar along the first axis to selectively position the horizontal spar at a height corresponding to the component of the associated vehicle, and wherein the carriage is configured to slide along at least a portion of the horizontal spar along a second axis substantially perpendicular to the first axis to selectively position the carriage at a location corresponding to the component of the associated vehicle.

In a seventh aspect, another dynamometer for use with an associated vehicle is provided. The dynamometer comprises: a roller assembly comprising at least one roller configured to interface with one or more corresponding wheels of the associated vehicle; a vertical spar extending upwardly relative to the roller assembly along a first axis; a horizontal spar attached to and extending outwardly away from the vertical spar; and a tilt actuator operatively connected to the horizontal spar and comprising an interface member configured to interface with a rider interaction component of the associated vehicle to align a virtual pivot point created by the tilt actuator with a true center of rotation of a wheel of the associated vehicle.

In an eighth aspect, another dynamometer for use with an associated vehicle is provided. The dynamometer comprises: a roller assembly comprising at least one roller configured to interface with one or more corresponding wheels of the associated vehicle; and a pedal control assembly. The pedal control assembly comprises: a motor; and a crank arm operatively connected to the motor and configured to interface with a pedal component of the associated vehicle to transmit pedal motion from the motor to the pedal component of the associated vehicle.

In a ninth aspect, another dynamometer for use with an associated vehicle is provided. The dynamometer comprises: a roller assembly comprising at least one roller configured to interface with one or more corresponding wheels of the associated vehicle; and a throttle control assembly. The throttle control assembly comprises: a motor; and a lever operatively connected to the motor and configured to interface with a throttle mechanism of the associated vehicle to transmit motion from the motor to the throttle mechanism of the associated vehicle.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure. It is to be understood that both the foregoing general description and the following detailed description are exemplary and explanatory only and are not restrictive, as claimed.

### BRIEF DESCRIPTION OF THE DRAWINGS

The description will be more fully understood with reference to the following figures. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 shows an a perspective view of a dynamometer provided with a roller assembly with a main roller and an idler roller, a flywheel assembly, a brake, a sensor, and a drive shaft according to an illustrative example of the present disclosure;

FIG. 2 shows a perspective view of the dynamometer of FIG. 1 provided with an additional idler roller according to an illustrative example of the present disclosure;

FIG. 3 shows a perspective view of a portion of the dynamometer of FIG. 1 with certain features removed to better illustrate internal features of the flywheel assembly according to an illustrative example of the present disclosure;

FIG. 4 shows a perspective view of the dynamometer of FIG. 1 in use with an electronic bicycle and provided with a vertical spar and a horizontal spar according to an illustrative example of the present disclosure;

FIG. 5 shows a perspective view of the dynamometer of FIG. 1 provided with a vertical spar and a horizontal spar according to an illustrative example of the present disclosure;

FIG. 6 shows a front view of the dynamometer of FIG. 5;

FIG. 7 shows a side view of the dynamometer of FIG. 5;

FIG. 8 shows a top view of the dynamometer of FIG. 5;

FIG. 9 shows a perspective view of a portion of a vertical spar according to an illustrative example of the present disclosure;

FIG. 10 shows a perspective view of a modular dynamometer system including a first modular dynamometer and a second modular dynamometer selectively positionable relative to one another according to an illustrative example of the present disclosure;

FIG. 11 shows a top view of the modular dynamometer system of FIG. 10 in use with a side-by-side vehicle with a laterally-spaced wheel configuration and with the first and second dynamometers positioned side-by-side according to an illustrative example of the present disclosure;

FIG. 12 shows a top view of the modular dynamometer system of FIG. 10 in use with an electronic bicycle with a longitudinally-spaced wheel configuration and with the first and second dynamometers positioned fore-aft of one another according to an illustrative example of the present disclosure;

FIG. 13 shows a side view of the dynamometer of FIG. 1 provided with a vertical spar, a horizontal spar, and a tilt actuator according to an illustrative example of the present disclosure;

FIG. 14 shows a perspective view of a tilt actuator according to an illustrative example of the present disclosure;

FIG. 15 shows a side view of the tilt actuator of FIG. 14;

FIG. 16 shows a cross-sectional view of the tilt actuator of FIG. 14 in use with a vehicle having a rider interaction component positioned below a true center of rotation of a wheel of the vehicle;

FIG. 17 shows a cross-sectional of the tilt actuator of FIG. 14 in use with a vehicle having a rider interaction component positioned above a true center of rotation of a wheel of the vehicle;

FIG. 18 shows a perspective view of the dynamometer of FIG. 1 in use with an electronic bicycle and provided with a pedal control assembly according to an illustrative example of the present disclosure;

FIG. 19 shows a perspective view of a pedal control assembly according to an illustrative example of the present disclosure;

FIG. 20 shows a perspective view of the dynamometer of FIG. 1 in use with an electronic bicycle and provided with a throttle control assembly according to an illustrative example of the present disclosure; and.

FIG. 21 shows a perspective view of a throttle control assembly according to an illustrative example of the present disclosure.

The figures depict various examples for purposes of illustration only. One skilled in the art will readily recognize from the following discussion that alternative examples of the devices and features illustrated herein may be employed without departing from the principles described herein.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

Some examples will now be described more fully hereinafter with reference to the accompanying drawings, in which some, but not necessarily all examples are shown. Indeed, various examples may be embodied in many different forms and should not be construed as limited to the examples set forth herein. It is to be understood that the devices described herein are not limited to specific components or to particular implementations. It is also to be understood that the terminology used herein is for the purpose of describing particular examples only and is not intended to be limiting. It is to be appreciated that examples of the devices described herein are not limited in application to the details of construction and the arrangement of components set forth in the following description or illustrated in the accompanying drawings. The devices are capable of implementation in other examples and of being practiced or of being carried out in various ways. Examples of specific implementations are provided herein for illustrative purposes only and are not intended to be limiting. In particular, features, functionality, and characteristics described in connection with any one or more examples are not intended to be excluded from a similar role in any other examples. Like reference numerals refer to like components throughout unless expressly indicated otherwise or indicated otherwise by context.

Any ranges cited herein are inclusive unless expressly indicated otherwise or indicated otherwise by context. The terms “substantially,” “approximately,” and “about” are used to describe and account for small fluctuations or standard tolerances. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

As used herein, the term “exemplary” is not intended to convey any qualitative assessment, but, instead, merely to convey an illustration of an example. References to an “example” or the like means that the particular feature, function, or characteristic being described is included in at least one, but not necessarily all, examples or embodiments. Occurrences of such phrases in this description do not necessarily all refer to the same example, nor are they necessarily mutually exclusive. Thus, use of any such terms should not be taken to limit the spirit and scope of the present disclosure.

As used herein, the term “or” is inclusive and not exclusive, unless expressly indicated otherwise or indicated otherwise by context. By way of example, as used herein, “A or B” means “A, B, or both,” unless expressly indicated otherwise or indicated otherwise by context. Moreover, “and” is both joint and several, unless expressly indicated otherwise or indicated otherwise by context. By way of example, as used herein, “A and B” means “A and B, jointly or severally,” unless expressly indicated otherwise or indicated otherwise by context.

As used herein, reference to a device or system or a component of a device or system being “configured to” or the like (e.g., “adapted to,” “operable to,” “operative”) to perform a particular function encompasses that device, system, component, whether or not it or that particular function is performed (e.g., connected, activated, unlocked) as long as that device, system, or component is so configured, adapted, operable, or operative. Additionally, although this disclosure describes or illustrates particular examples as providing particular advantages, other examples are not necessarily so limited and may provide none, all, fewer, more, of these advantages.

While aspects described with respect to particular drawings, devices, systems, or components herein may differ, it will be understood by those of skill in the art, on review of the disclosures herein, that components can be added, removed, consolidated, divided, re-ordered, and the like, without departing from the scope or spirit of the disclosure. Examples and embodiments may also be combined, in whole or in part, without departing from the scope or spirit of the disclosure.

The dynamometers described herein are adapted for use with an associated vehicle. As used herein, the term “vehicle” encompasses any powered device used for transportation (e.g., of people and/or goods), such as an all-terrain vehicle, an off-road vehicle, a side-by-side vehicle, an electric scooter, an electric skateboard, an electric bicycle, an electric unicycle, a hoverboard, a segway, an unmanned product delivery vehicle, and the like.

The dynamometers described herein may, in examples, be designed to be modular. As used herein, the term “modular” means the dynamometer includes particular feature(s), functionality, and/or characteristic(s) designed for flexibility and/or variety in use, such as to make the dynamometer suitable for use in a system with one or more additional dynamometers and/or components that can be selectively adjusted, employed, or removed as desired to suit a particular application.

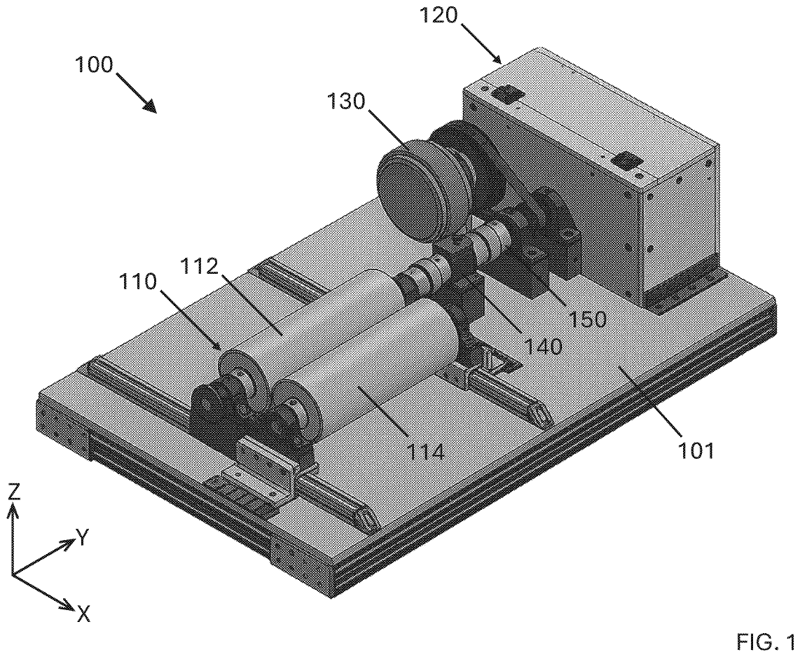

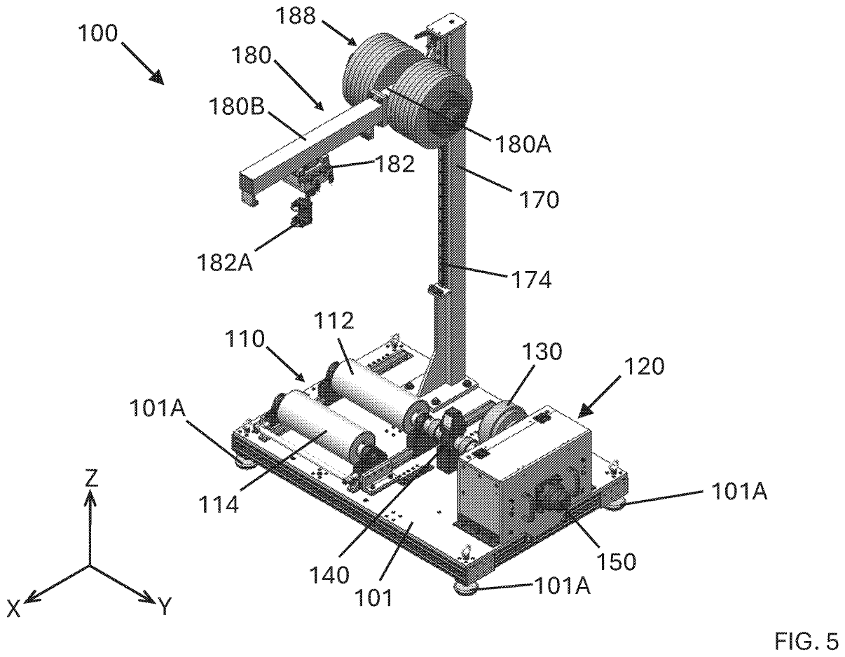

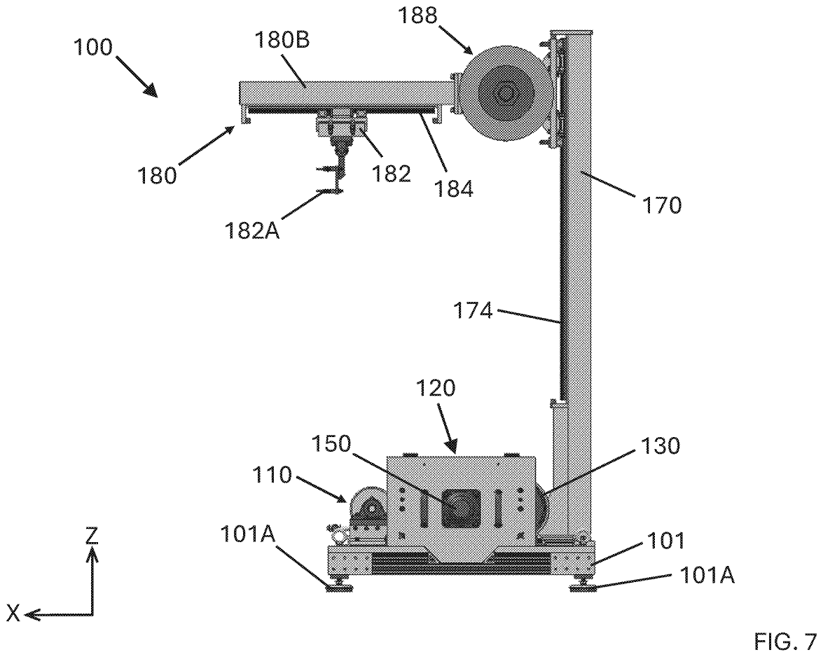

With reference to the drawings, FIGS. 1-8 show a dynamometer 100 according to an illustrative example of the present disclosure. The dynamometer 100 illustrated in FIGS. 1-8 is generally considered a modular dynamometer, as described herein.

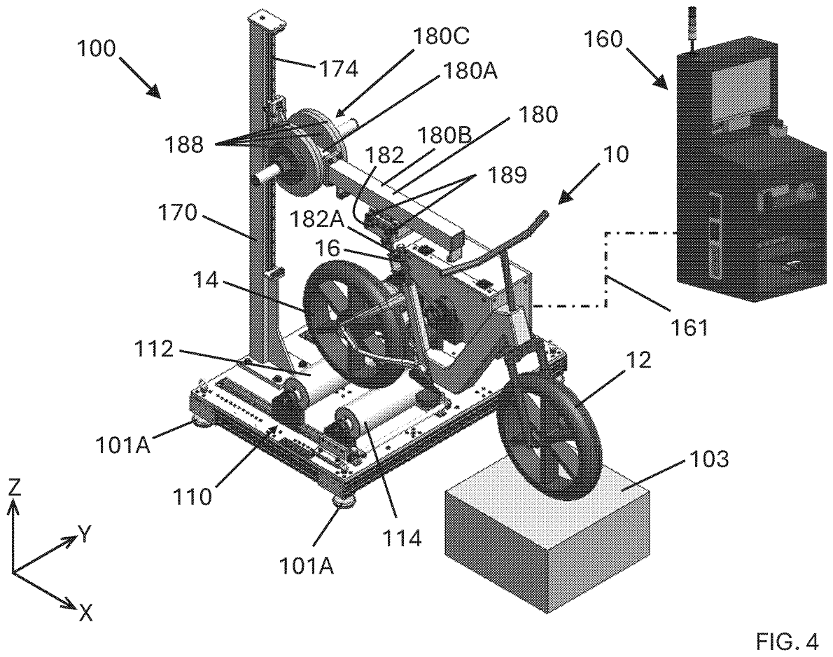

As illustrated in the illustrative example of FIG. 1, the dynamometer 100 includes a roller assembly 110. The roller assembly 110 includes one or more rollers. In the illustrative example of FIG. 1, the roller assembly 110 includes a main roller 112 and an idler roller 114. As illustrated, the main roller 112 and the idler roller 114 are generally spaced apart from one another, but the idler roller 114 may be moved relative to the main roller 112 and be moved proximal to (e.g., in near abutment with) the main roller 112. As may be more readily understood with reference to FIG. 4, the roller assembly 110 is configured to interface with (e.g., contact) one or more corresponding wheels 12, 14 of an associated vehicle 10, such as by supporting such wheel(s) thereon and/or, in the case of multiple rollers, by at least partially receiving such wheel(s) therebetween. As may be likewise readily understood with reference to FIG. 4, the wheel(s) 14 of the associated vehicle 10 operatively connected to the motor, drivetrain, or the like thereof can be supported by the roller assembly 110, and any additional wheel(s) 12 of the associated vehicle 10 (e.g., those wheels that are not operatively connected to the motor, drivetrain, or the like thereof) can be positioned away from the roller assembly 110 and supported by, for example, a separate riser 103 or the like. The roller assembly 110 can include any number of rollers, which can be sized and shaped as desired to suit a particular application. In this regard, the roller(s) of the roller assembly 110 can be any structure configured to interface with (e.g., contact) one or more corresponding wheels 12, 14 of an associated vehicle 10, such as by supporting such wheel(s) thereon. In some examples, the roller(s) of the roller assembly 110 can have a substantially cylindrical shape such that the roller(s) are able to rotate with the wheel(s) of the associated vehicle 10, such as is illustrated in FIG. 4, although other examples are not so limited. For example, in other embodiments, the roller(s) of the roller assembly 110 can be implemented as and/or with other structures capable of moving with the wheel(s) of the associated vehicle 10, such as an endless flat track belt, a conveyor, or the like.

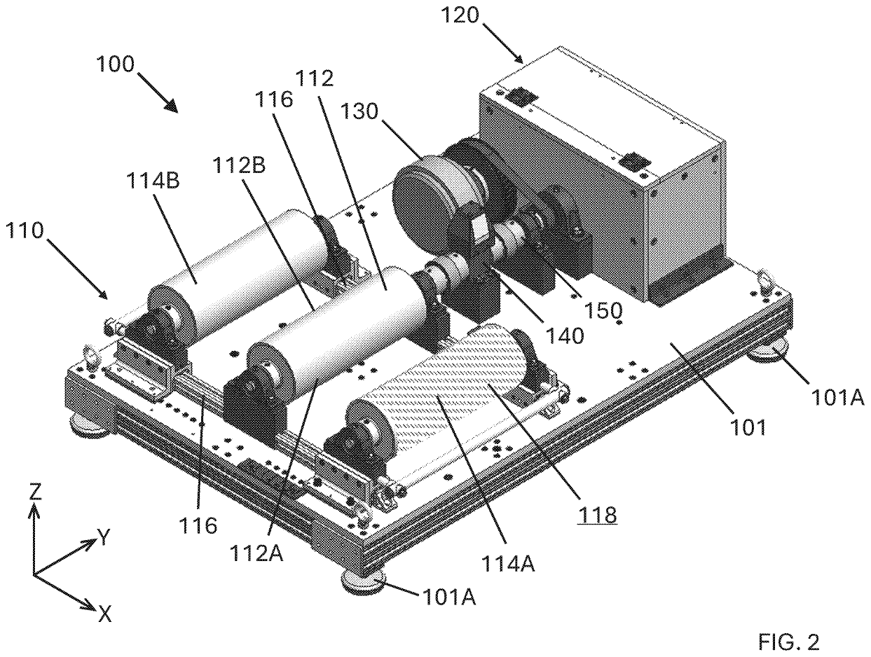

With reference to FIG. 2, the roller assembly 110 can include a rail 116 to which the roller(s) thereof are selectively and removably attached. The roller(s) can be attached to the rail 116 by any suitable means, such as by employing one or more fasteners. In the illustrative example of FIG. 2, the roller assembly 110 includes a pair of spaced-apart rails 116 along opposite sides of each roller. For example, the rail(s) 116 can extend in a first direction along an axis X away from a first side 112A of the main roller 112 and in an opposite second direction along the axis X away from an opposite second side 112B of the main roller 112.

With continued reference to FIG. 2, the roller assembly 110 may, in certain examples, include more than one idler roller, although other examples are not so limited. For example, in the illustrative example of FIG. 2, the roller assembly 110 includes a main roller 112, a first idler roller 114A, and a second idler roller 114B. When multiple idler rollers are employed, they can generally be spaced apart from one another on opposite sides of the main roller 112, such as is illustrated in FIG. 2 with the first idler roller 114A in a first position in which the first idler roller 114A is disposed along the first side 112A of the main roller 112 and the second idler roller 114B in a second position in which the second idler roller 114B is disposed along the second side 112B of the main roller 112, although other configurations are possible and can be employed as desired to suit a particular application.

In other examples, one or more rollers of the roller assembly 110 can define an even (e.g., smooth) surface, such as is illustrated with respect to idler roller 114B in FIG. 2. In examples, one or more rollers of the roller assembly 110 can define an uneven (e.g., non-smooth) surface 118, such as is illustrated with respect to idler roller 114A in FIG. 2. For example, at least a portion of an outer of the roller(s) can be uneven (e.g., textured), such as by including raised and/or recessed features (e.g., knurls, bumps, nodules). In this way, such roller(s) may advantageously be used to simulate or otherwise represent bumps in asphalt, cobblestone, or rough or high friction surfaces or roadways, or the like. It is contemplated that the uneven surface 118 of the roller(s) could be provided by modifying or otherwise forming one or more features in an outer surface (e.g., an otherwise smooth outer surface) of such roller(s) or by adding (e.g., connecting) an attachment (e.g., a clamshell attachment) to or about an outer surface of such roller(s).

In examples, the idler roller(s) 114 can be moved (e.g., along the rail(s) 116) relative to the main roller 112 to thereby adjust a spacing between the main roller 112 and such idler roller(s) 114. In this way, the roller assembly 110 can be adjusted to advantageously accommodate (e.g., by interfacing with) a variety of wheels of a vehicle (e.g., wheels of various diameters and/or spacing).

The roller assembly 110 can generally be sized, shaped, constructed, and configured as desired to suit a particular application.

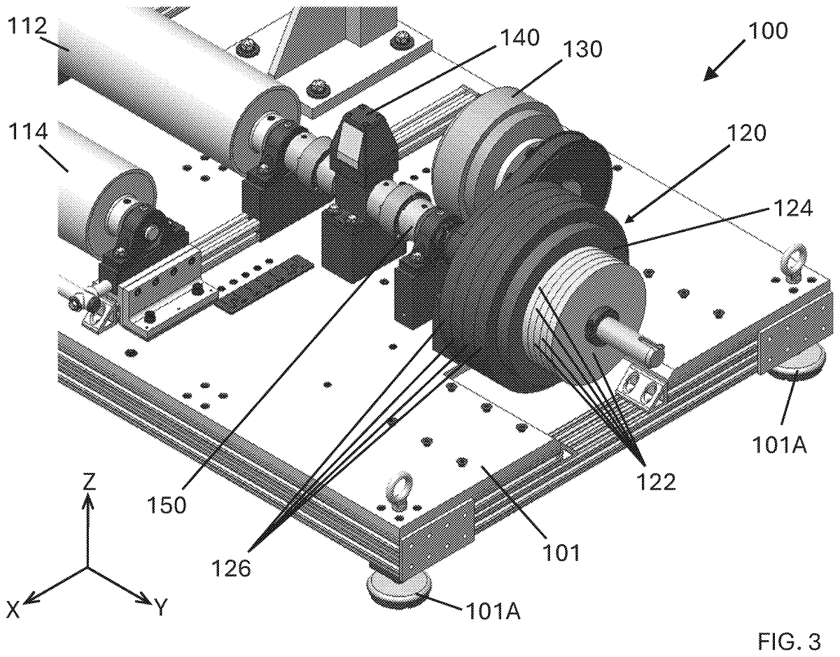

With continued reference to FIG. 1 and FIG. 2 and additional reference to FIG. 3, the dynamometer 100 can include a flywheel assembly 120. The flywheel assembly 120 is generally configured to simulate an inertial load on the associated vehicle 10. The amount or extent of inertial load is selectively adjustable by adding as few or as many flywheels to the flywheel assembly 120 and/or arranging the flywheels of the flywheel assembly 120 as desired to suit a particular application. For example, in the illustrative example of FIG. 3, the flywheel assembly 120 includes multiple flywheels 122 of a first inertia, one flywheel 124 of a second inertia, and multiple flywheels 126 of a third inertia, although other examples are not so limited. In the illustrative example of FIG. 3, the flywheel assembly 120 is operatively connected to the roller assembly 110, such as by a drive shaft 150 extending between and interconnecting the flywheel assembly 120 and the main roller 112. The flywheel assembly 120 (and the flywheels thereof) can generally be sized, shaped, constructed, and configured as desired to suit a particular application, and any desired number and inertia of flywheels can be employed as desired to suit a particular application. It will be appreciated that the flywheel assembly 120 can simulate the inertial load on the associated vehicle 10 via the main roller 112 and/or the inertial load on the associated vehicle 10 can simulated by implementing and/or employing other structures or means (e.g., via mechanical means, hydraulic means, or the like, including combinations thereof).

The dynamometer 100 can include a brake 130, such as an electronic brake. The brake 130 is generally configured to simulate a parasitic load on the associated vehicle 10 (e.g., a load associated with aerodynamic drag, hills, or the like), such as by increasing the current. The amount or extent of parasitic load is selectively adjustable by operating the brake 130 (e.g., using a controller 160) as desired to suit a particular application. In the illustrative example of FIG. 3, the brake 130 is operatively connected to the roller assembly 110, such as by being operatively connected (e.g., via a belt) to the drive shaft 150 connected to the main roller 112. In the illustrative example of FIG. 3, the brake 130 is positioned between the roller assembly 110 and the flywheel assembly 120, although other configurations are possible. The brake 130 can generally be sized, shaped, constructed, and configured as desired to suit a particular application. It will be appreciated that the brake 130 can be mechanical, electronic, or the like, including combinations thereof.

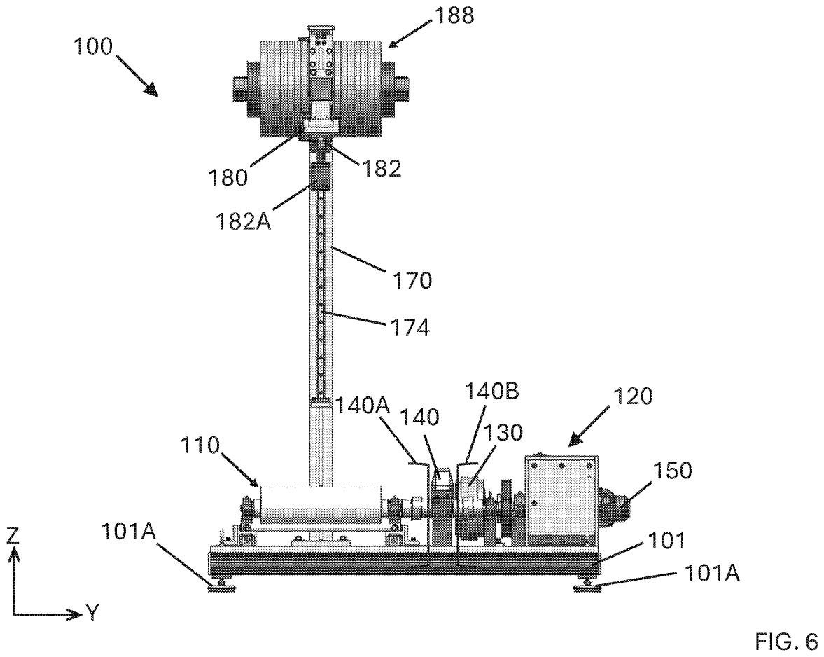

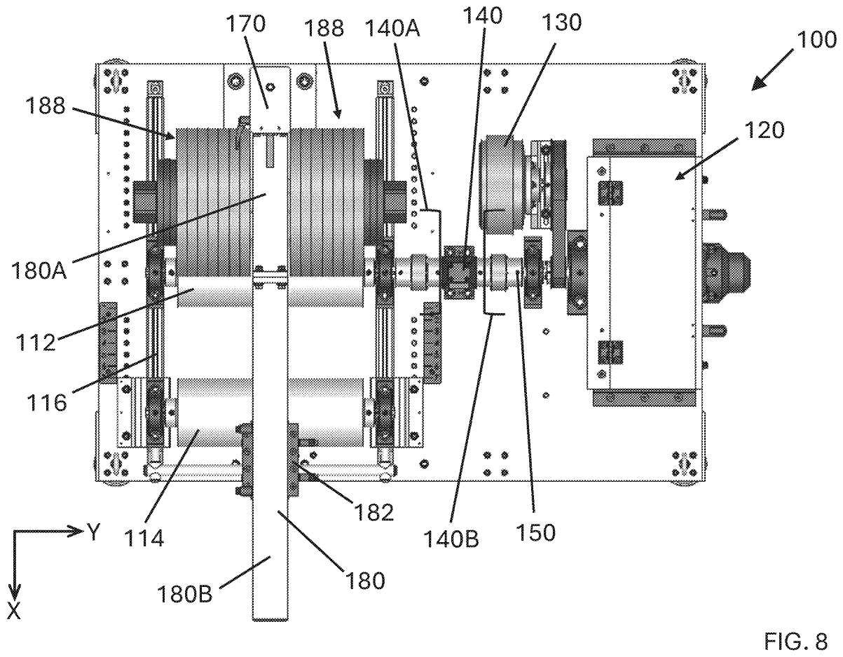

The dynamometer 100 can include a sensor 140. The sensor 140 is generally configured to receive one or more inputs from the associated vehicle 10 and one or more loads from the dynamometer 100. The sensor 140 is connected to the roller assembly 110, such as by being operatively connected to the drive shaft 150 connected to the main roller 112. The sensor 140 is disposed between the roller assembly 110 and the brake 130. As may be more readily understood with reference to FIG. 6 and FIG. 8, in particular embodiments, the sensor 140 is positioned such that one or more inputs from the associated vehicle 10 are on (e.g., received from) a first side 140A of the sensor 140 and one or more loads from the dynamometer 100, namely the flywheel assembly 120 and/or the brake 130 thereof, are on (e.g., received from) an opposite second side 140B of the sensor 140. In this way, by keeping the input(s) from the associated vehicle 10 (e.g., vehicle torque output/loading) and the load(s) from the dynamometer 100 (e.g., any disturbances/loads) separated (e.g., on opposite sides of the sensor 140), attributing data from the sensor is simplified, such as by more easily attributing torque at the sensor 140 to the associated vehicle and determining power at the wheel(s). The sensor 140 can generally be sized, shaped, constructed, and configured as desired to suit a particular application. By way of non-limiting example, the sensor 140 can be a torque transducer and/or the sensor 140 can be configured to measure a torque, a distance traveled, a speed of the associated vehicle, and the like, including combinations thereof.

The dynamometer 100 can include a drive shaft 150. The drive shaft 150 generally extends between and interconnects the flywheel assembly 120 and the roller assembly 110, namely the main roller 112 thereof. The drive shaft 150 can generally be sized, shaped, constructed, and configured as desired to suit a particular application.

The dynamometer 100 can include a controller 160. The controller 160 is generally configured to control operation of the dynamometer 100, including the individual components thereof (e.g., the roller assembly 110, the brake 140, the actuator(s) 178, the pedal control assembly 200, the throttle control assembly 300), such as by receiving data (e.g., feedback) from the sensor 140 and controlling operation of the dynamometer 100 responsive to such data. As described herein, the controller 160 may be in signal communication with the dynamometer 100 (e.g., the sensor 140, the brake 130, the pedal control assembly 200, the throttle control assembly 300) for sending and/or receiving data, inputs, outputs, and the like to and/or from the dynamometer 100. In examples, one or more other components may likewise be in signal communication with the controller 160, such as via the sensor 140 or otherwise, as described herein. The controller 160 can generally be sized, shaped, constructed, and configured as desired to suit a particular application.

Turning specifically to FIGS. 4-8, the dynamometer 100 is illustrated with a vertical spar 170 and a horizontal spar 180. The vertical spar 170 extends upwardly along an axis Z relative to the roller assembly 110. The horizontal spar 180 is attached (e.g., directly) to the vertical spar 170. The horizontal spar 180 extends outwardly from the vertical spar 170 along an axis X substantially perpendicular to the axis Z along which the vertical spar 170 extends, such that at least a portion of the horizontal spar 180 can be positioned above the roller assembly 110 along the axis Z. The horizontal spar 180 can include a carriage 182. The carriage 182 is generally configured to interface (e.g., directly or indirectly) with a component (e.g., a rider interface component) of the associated vehicle 10 to apply a load to the component of the associated vehicle 10 and thereby simulate a load (e.g., rider weight) on the associated vehicle 10, such as via a vehicle interface component 182A operatively connected to the carriage 182. In the illustrative example of FIG. 4, the vehicle interface component 182A interfaces directly with a seat post 16 of the associated vehicle 10, although other examples are not so limited. The vertical spar 170 and the horizontal spar 180 can generally be sized, shaped, constructed, and configured as desired to suit a particular application. As will be appreciated, the terms “horizontal” and “vertical” are used herein to differentiate the spars and indicate direction relative to an absolute reference, i.e. ground level. The terms “horizontal” and “vertical” should be construed in their respective lay senses as extending generally continuously the same distance from ground level, not strictly in mathematical terms as requiring that they remain at a constant angle relative to one another when extended for an infinite distance. In aspects, a “vertical” spar can extend at an angle of 90°±30° from ground level, and a “horizontal” can extend at an angle of 0°±30° from ground level.

In certain examples, the horizontal spar 180 can be configured to slide along at least a portion of the vertical spar 170, namely along the axis Z along which the vertical spar 170 extends. For example, the vertical spar 170 can include or define a low-friction rail 174, and the horizontal spar 180 can be configured to slide along the low-friction rail 174 of the vertical spar 170. In examples, the vertical spar 170 can include one or more bumpers, such as proximate opposite upper and lower ends of the vertical spar 170, and such bumper(s) can be configured to limit the travel of the horizontal spar 180 along the vertical spar 170. By configuring the horizontal spar 180 to be slidable along at least a portion of the vertical spar 170, the horizontal spar 180 can be selectively positioned at a height corresponding to the component of the associated vehicle 10. In this way, the dynamometer 100 can be used with a variety of different vehicles, and the horizontal spar 180 can be selectively positioned at an appropriate height for configuring the carriage 182 (e.g., the vehicle interface component 182A connected thereto) to interface with the component of the associated vehicle 10 to simulate the rider weight on the associated vehicle by applying the load to the component of the associated vehicle 10. The positioning of the horizontal spar 180 along the vertical spar 170 can generally be constructed and configured as desired to suit a particular application. By way of non-limiting example, the horizontal spar 180 can be configured to slide about 50″ along the vertical spar 170, although other examples are not so limited.

In certain examples, the carriage 182 (e.g., and the vehicle interface component 182A connected thereto) can be configured to slide along at least a portion of the horizontal spar 180, namely along the axis X along which the horizontal spar 180 extends. For example, the horizontal spar 180 can include or define a low-friction rail 184, and the carriage 182 can be configured to slide along the low-friction rail 184 of the horizontal spar 180. In examples, the horizontal spar 180 can include one or more bumpers, such as proximate opposite proximal and distal ends of the horizontal spar 180, and such bumper(s) can be configured to limit the travel of the carriage 182 along the horizontal spar 180. By configuring the carriage 182 to be slidable along at least a portion of the horizontal spar 180, the carriage 182 can be selectively positioned at a location corresponding to the component of the associated vehicle 10. In this way, the dynamometer 100 can be used with a variety of different vehicles, and the carriage 182 can be selectively positioned at an appropriate location for configuring the carriage 182 (e.g., the vehicle interface component 182A connected thereto) to interface with the component of the associated vehicle 10 to simulate the rider weight on the associated vehicle by applying the load to the component of the associated vehicle 10. The positioning of the carriage 182 along the horizontal spar 180 can generally be constructed and configured as desired to suit a particular application. By way of non-limiting example, the carriage 182 can be configured to slide about 26″ along the horizontal spar 180, although other examples are not so limited. In examples, a locking mechanism 189 can be provided for selectively locking and unlocking positioning of the carriage 182 along the horizontal spar 180. For example, the locking mechanism 189 can be configured to be selectively moved between (a) an unlocked configuration in which the carriage 182 is configured to freely slide along at least a portion of the horizontal spar 180 along the axis X and (b) a locked configuration in which the carriage 182 is prevented from sliding along of the horizontal spar 180 along the axis X. The locking mechanism 189 can generally be sized, shaped, constructed, and configured as desired to suit a particular application. By way of non-limiting example, the locking mechanism 189 can include one or more fasteners (e.g., spring-loaded pins) configured to pass through a selected aperture defined by the horizontal spar 180 and interface with the carriage 182 and/or one or more clamps, brakes, or the like for interfacing with the carriage 182. In this way, the carriage can be selectively positioned and locked at a desired location, as described herein.

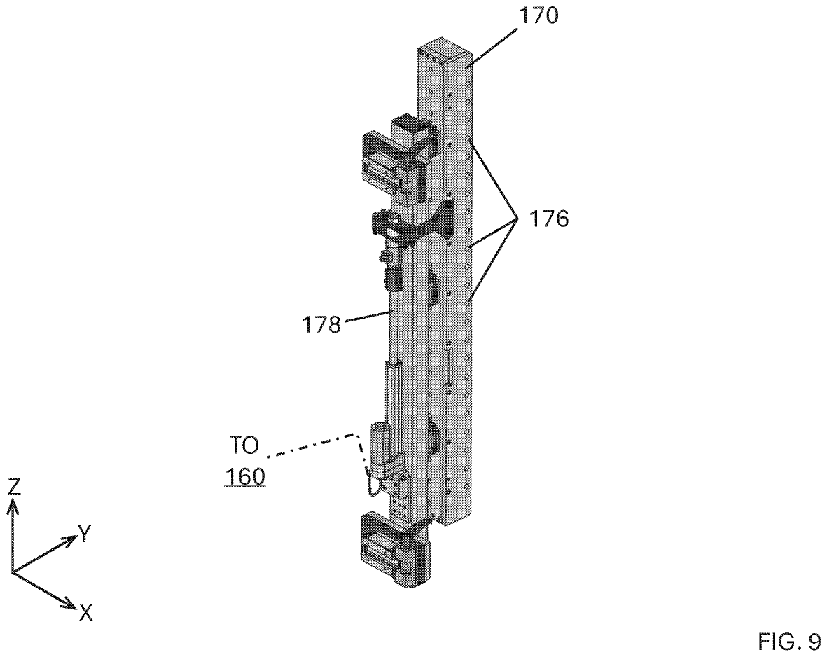

With reference to FIG. 9, the vertical spar 170 can, in certain examples, include or define one or more apertures 176 spaced apart from one another (e.g., along axis Z). The horizontal spar 180 can be attached (e.g., directly) to the vertical spar 170 via a fastener (e.g., a spring-loaded pin) passing through a selected one of the apertures 176 and interfacing with the horizontal spar 180. In this way, the horizontal spar 180 can be selectively positioned and locked at a desired height, as described herein. In specific examples, selective positioning of the horizontal spar 180 along the vertical spar 170 can be electronically controlled. For example, the vertical spar 170 can, in certain examples, include an actuator 178, and the actuator 178 can be power-adjusted (e.g., by controller 160, via mechanical means, electronic means, pneumatic means, hydraulic means, or the like, including combinations thereof) to selectively position the horizontal spar 180 at a desired height, as described herein. For example, the controller 160 may receive data (e.g., feedback) from the actuator 178 and control operation of the actuator 178, as described herein, responsive to such data. In specific examples, selective positioning of the carriage 182 along the horizontal spar 180 can be electronically controlled. For example, the horizontal spar 180 and/or the carriage 182 may include an actuator (not shown) or other device for power-adjusting (e.g., by controller 160, via mechanical means, electronic means, pneumatic means, hydraulic means, or the like, including combinations thereof) the carriage 182 to selectively position the carriage 182 at a desired location, as described herein. For example, the controller 160 may receive data (e.g., feedback) from such an actuator and control operation of such actuator, as described herein, responsive to such data.

As may be more readily understood with reference to FIG. 8, the horizontal spar 180 can, in certain examples, be defined by multiple portions attached to one another. In this way, a variety of extensions can be provided, and a suitable one of the extensions can be selected for a particular application, thereby ensuring the carriage 182 is selectively positioned at an appropriate location for configuring the carriage 182 (e.g., the vehicle interface component 182A connected thereto) to interface with the component of the associated vehicle 10 to simulate the rider weight on the associated vehicle by applying the load to the component of the associated vehicle 10, as described herein. In the illustrative example of FIG. 8, the horizontal spar 180 can include or be defined by a proximal portion 180A and a distal portion 180B, although other configurations are possible and more or fewer portions can be employed. The proximal portion 180A of the horizontal spar 180 is generally configured to be attached to the vertical spar 170. In certain examples, the proximal portion 180A may be fixedly and non-removably attached to the vertical spar 170, and the aforementioned adjustability of the horizontal spar 180 may be achieved by providing one or more additional portions removably attachable to the proximal portion 180A, although other examples are not so limited. The proximal portion 180A extends outwardly from the vertical spar 170 along the axis X. The distal portion 180B is attached (e.g., directly and removably) to the proximal portion 180A and extends outwardly from the proximal portion 180A along the axis X. In examples, the carriage 182 can be configured to slide along at least a portion of the distal portion 180B of the horizontal spar 180, as described herein.

In examples, the proximal portion 180A and/or the distal portion 180B of the horizontal spar 180 can define a mechanical ballast loading location 180C. The mechanical ballast loading location 180C is generally a location configured to receive any desired number of weight plates 188 to simulate the rider weight on the associated vehicle 10, as described herein. In specific examples, the rider weight on the associated vehicle 10 can be simulated by applying the load to the component of the associated vehicle 10 (e.g., electronically), as described herein. As will appreciated, the rider weight on the associated vehicle 10 can be simulated in a variety of ways, as described herein, such as by adding a desired number of weight plates to a mechanical ballast loading location, applying a load via a carriage, and/or applying a load via a vehicle interface component (e.g., via ratchet strap loading).

As may now be readily understood, the horizontal spar 180 can be configured to travel(e.g., slide) along at least a portion of the vertical spar 170 along an axis Z, and the carriage 182 (e.g., and the vehicle interface component 182A connected thereto) can be configured to travel (e.g., slide) along at least a portion of the horizontal spar 180 along an axis X substantially perpendicular to the axis Z. In certain examples, the vertical spar 170 may also be configured to travel (e.g., slide) relative to the roller assembly 110 along an axis Y substantially perpendicular to the axis X and axis Z (e.g., along an axis Y along which the roller(s) are elongated), such that the vertical spar 170 can be selectively positioned at a desired location relative to the roller assembly 110. In this way, the carriage 182 attached to the horizontal spar 180 can be adjusted along at least three dimensions, although other examples are not so limited. Although the drawings are illustrated with a single vertical spar 170 and a single horizontal spar 180, it will be appreciated that any number of spars can be employed as desired to suit a particular application. By way of non-limiting example, the dynamometer 100 can include a pair of vertical spars 170 and a corresponding pair of horizontal spars 180, which may advantageously allow permit the dynamometer 100 to interface with the associated vehicle 10 at multiple locations (e.g., by interfacing with multiple rider interface components of the associated vehicle 10).

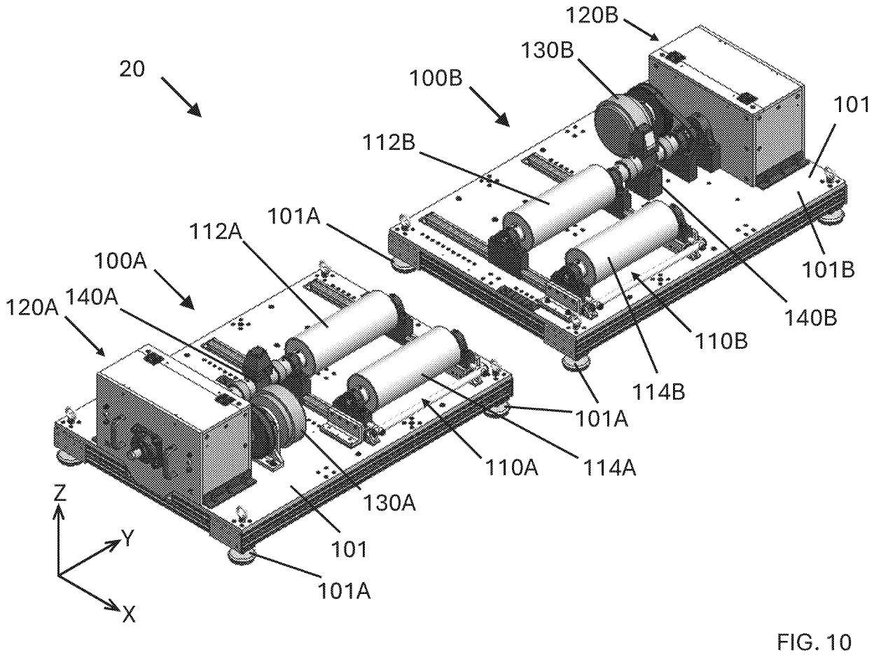

Turning now to FIGS. 10-12, a dynamometer system 20 is shown according to an illustrative example of the present disclosure. The dynamometer system 20 illustrated in FIGS. 10-12 is generally considered a modular dynamometer system, as described herein.

As illustrated in the illustrative example of FIG. 10, the dynamometer system 20 includes a first modular dynamometer 100A and a second modular dynamometer 100B. In the illustrative example of FIG. 10, the first modular dynamometer 100A and the second modular dynamometer 100B are generally mirror images of one another, although other examples are not so limited. For example, to suit particular applications, it may be desirable to provide one of the modular dynamometers with a vertical spar and a horizontal spar, as described herein, while omitting a vertical spar and a horizontal spar from another of the modular dynamometers. Additionally, although the drawings are illustrated with two modular dynamometers, it will be appreciated that modular dynamometer system 20 could be employed with additional dynamometers, as desired to suit a particular application. As will be appreciated, the modular dynamometers of modular dynamometer system 20 can be sized, shaped, constructed, and configured as desired to suit a particular application with some or all of the features, functionality, and/or characteristics of modular dynamometer 100 described herein, and, in the interest of brevity, such features, functionality, and/or characteristics are not necessarily repeated with respect to modular dynamometer system 20.

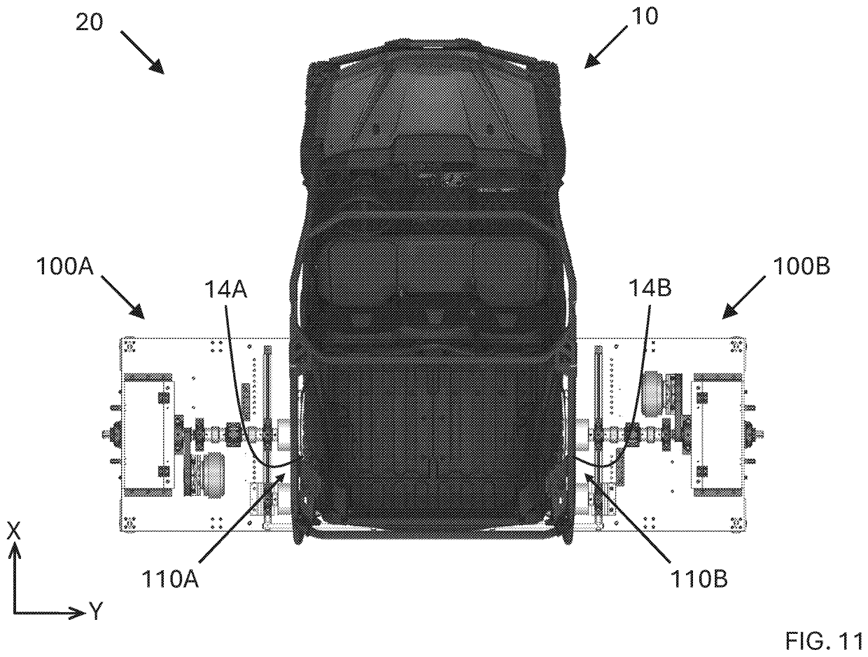

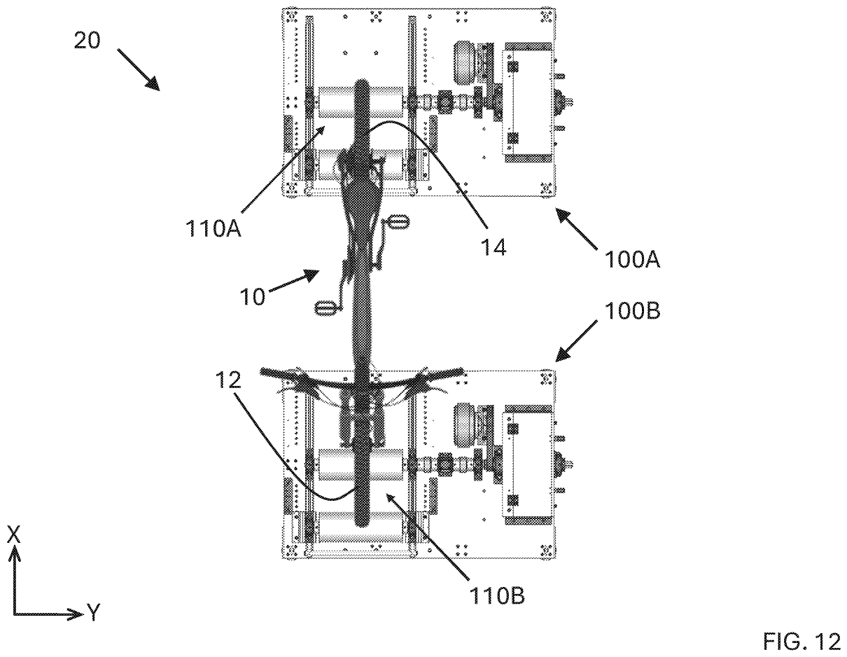

As will be appreciated, the modular dynamometers of modular dynamometer system 20 can be selectively positioned relative to one another in any configuration as desired to suit a particular application. By way of non-limiting example, in the illustrative example of FIG. 11, the modular dynamometer system 20 can be particularly adapted for use with an associated vehicle 10 (e.g., a side-by-side vehicle) having a laterally-spaced wheel configuration (e.g., with laterally-spaced wheels 14A, 14B operatively connected to the motor, drivetrain, or the like of the associated vehicle 10) by selectively positioning the first modular dynamometer 100A and the second modular dynamometer 100B side-by-side (e.g., along axis Y). As such, the roller assembly 110A of the first modular dynamometer 100A can be configured to interface with one side wheel 14A of the associated vehicle 10 (e.g., a driver's-side rear wheel), and the roller assembly 110B of the second modular dynamometer 100B can be configured to interface with a side wheel 14B on an opposite side of the associated vehicle 10 (e.g., a passenger's-side rear wheel). By way of further non-limiting example, in the illustrative example of FIG. 12, the modular dynamometer system 20 can be particularly adapted for use with an associated vehicle 10 (e.g., an electronic bicycle) having a longitudinally-spaced wheel configuration (e.g., with longitudinally-spaced wheels 12, 14, either or both of which may be operatively connected to the motor, drivetrain, or the like of the associated vehicle 10) by selectively positioning the first modular dynamometer 100A and the second modular dynamometer 100B fore-aft of one another (e.g., along axis X). As such, the roller assembly 110A of the first modular dynamometer 100A can be configured to interface with a rear wheel 14 of the associated vehicle 10, and the roller assembly 110B of the second modular dynamometer 100B can be configured to interface with a front wheel 12 of the associated vehicle 10. Though omitted for viewability, it is to be understood that, as described herein, either or both of the first modular dynamometer 100A and the second modular dynamometer 100B could include a vertical spar, a horizontal spar, and/or associated components thereof, as desired to suit a particular application.

In examples, to suit particular applications, it may be advantageous to operate the first modular dynamometer 100A and the second modular dynamometer 100B jointly or separately. For example, the roller assembly 110A of the first modular dynamometer 100A can be operated jointly or separately from the roller assembly 110B of the second modular dynamometer 100B. In examples, the roller assembly 110A of the first modular dynamometer 100A can be configured such that the roller(s) thereof rotate in a first circumferential direction, and the roller assembly 110B of the second modular dynamometer 100B can be configured such that the roller(s) thereof rotate in a second circumferential direction that is the same as or opposite the first circumferential direction, as desired to suit a particular application. In specific examples, the roller assembly 110A of the first modular dynamometer 100A can, in examples, be operatively connected to the roller assembly 110B of the second modular dynamometer 100B, such as by employing a common drive shaft between the roller assembly 110A of the first modular dynamometer 100A and the roller assembly 110B of the second modular dynamometer 100B or otherwise operatively connecting respective drive shafts to one another.

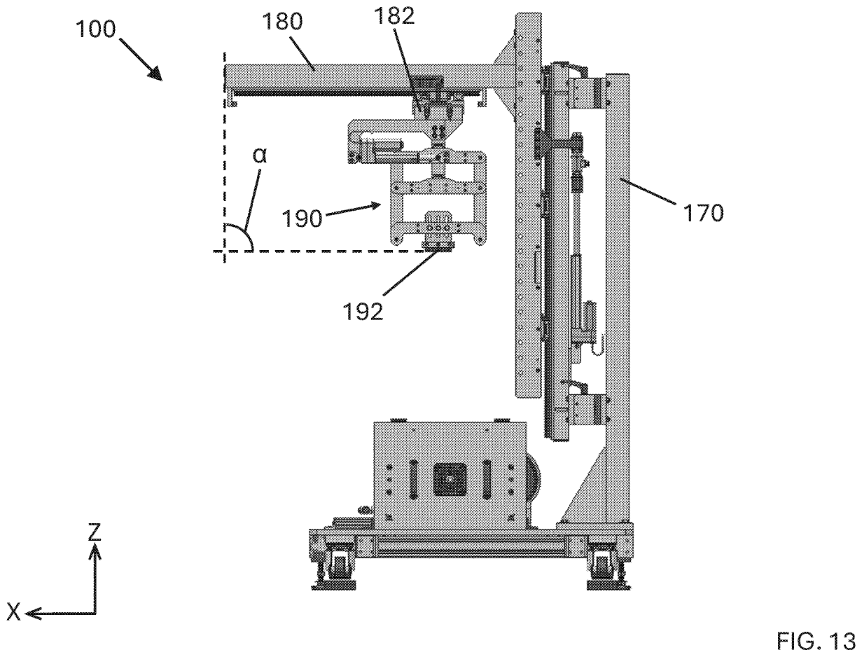

Turning now to FIGS. 13-17, a tilt actuator 190 of the dynamometer 100 is shown according to an illustrative example of the present disclosure.

The tilt actuator 190 includes an interface member 192 configured to interface with a rider interaction component 16 (e.g., a footpad) of the associated vehicle 10. In examples, the interface member 192 can include or define a compliant surface 192A (e.g., a pad) configured to simulate a foot applying a force to the rider interaction component 16 of the associated vehicle 10. The tilt actuator 190 is generally connected to the horizontal spar 180, such as by being connected to the carriage 182, such that the tilt actuator 190 is configured to slide along at least a portion of the horizontal spar 180 along the axis to selectively position the tilt actuator at a location corresponding to the rider interface component 16 of the associated vehicle 10.

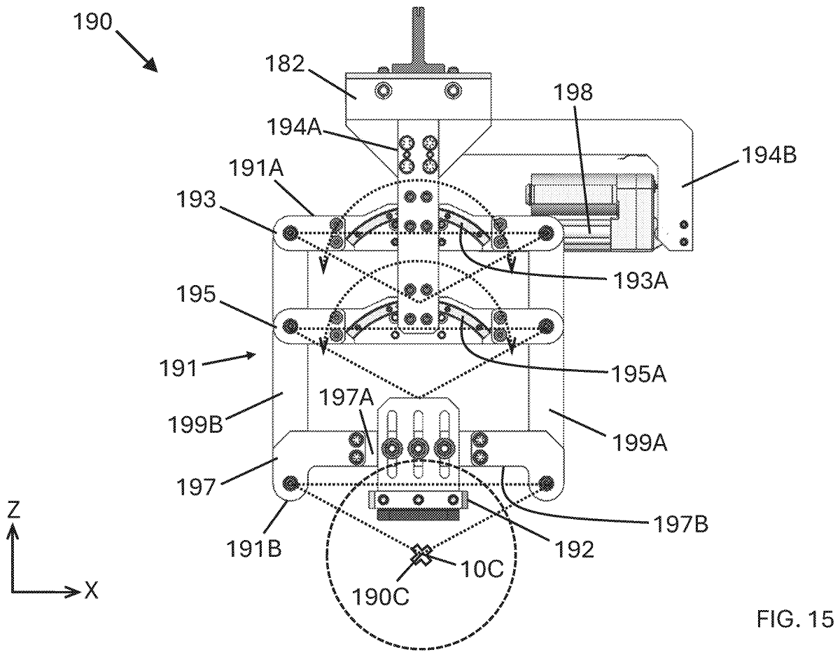

As may be necessary in particular applications, the tilt actuator 190 can be configured to interface with the rider interface component 16 of the associated vehicle 10 by adjusting an angle α of the interface member 192 relative to an axis Z (e.g., an angle between the interface member 190 and the horizontal spar 180 and/or the vertical spar 170; refer to FIG. 13). As may be more readily understood with reference to FIGS. 15-17, the tilt actuator 190 is particularly configured to interface with the rider interaction component 16 of the associated vehicle 10 to align a virtual pivot point 190C created by the tilt actuator 190 with a true center of rotation 10C of a wheel 12 of the associated vehicle 10, as described herein. In specific examples, selective adjusting of the angle α of the interface member 192 relative to the axis Z can be electronically controlled. For example, the tilt actuator 190 can, in certain examples, include an actuator 198, and the actuator 198 can be power-adjusted (e.g., by controller 160, via mechanical means, electronic means, pneumatic means, hydraulic means, or the like, including combinations thereof) to selectively adjust the angle α of the interface member 192 relative to an axis Z, as described herein, such as by driving the tilt actuator 190 along axis X substantially perpendicular to axis Z. For example, the controller 160 may receive data (e.g., feedback) from the actuator 198 and control operation of the actuator 198, as described herein, responsive to such data.

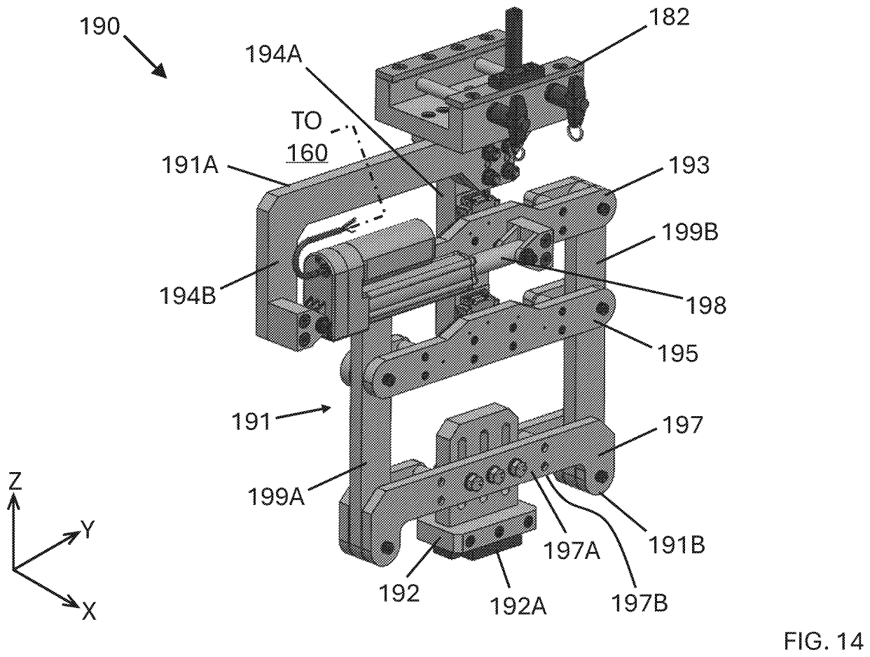

The tilt actuator 190 can, in examples, include a parallelogram linkage 191 defining an upper end 191A and an opposite lower end 191B. As shown in the illustrative example of FIG. 14, the parallelogram linkage 191 includes an upper link 193, a lower link 197, an intermediate link 195 disposed between the upper link 193 and the lower link 197, and a pair of side links 199A, 199B each extending between and interconnecting the upper link 193, the intermediate link 195, and the lower link 197. The parallelogram linkage 191 can further include a vertical member 194A and a driving member 194B. The vertical member 194A extends downwardly along axis Z between the horizontal spar 180, the upper link 193, and the intermediate link 195 and operatively connects the parallelogram linkage 191 to the horizontal spar 180 (e.g. via the carriage 182). The driving member 194B is operatively connected to the actuator 198 and extends between and interconnects the vertical member 194A and the upper link 193. The interface member 192 is operatively connected to the lower link 197, and, in particular examples, is adjustably connected to the lower link 197 such that a distance between the compliant surface 192A and a main body 197A of the lower link 197 can be selectively adjusted along the axis Z. The actuator 198 is operatively connected to the upper link 193 and configured to drive the upper link 193 to adjust the angle α of the interface member 192 relative to the axis Z. As may be more readily understood with reference to FIG. 15, in specific examples, the upper link 193 can define a guide rail 193A about which the upper link 193 is configured to rotate as the actuator 198 drives the tilt actuator 190, and the intermediate link 195 can likewise define a guide rail 195A about which the intermediate link 195 is configured to rotate as the actuator 198 drives the tilt actuator 190.

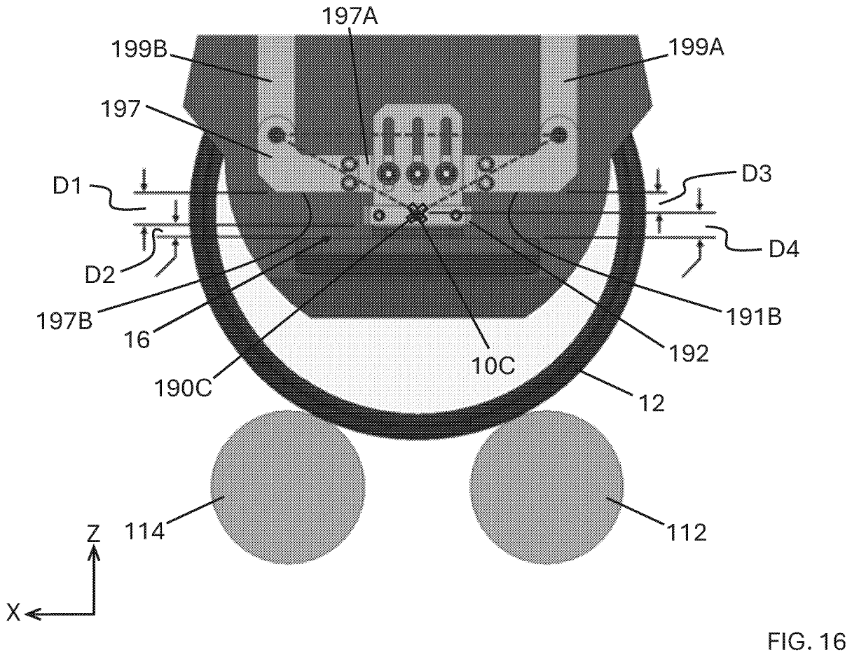

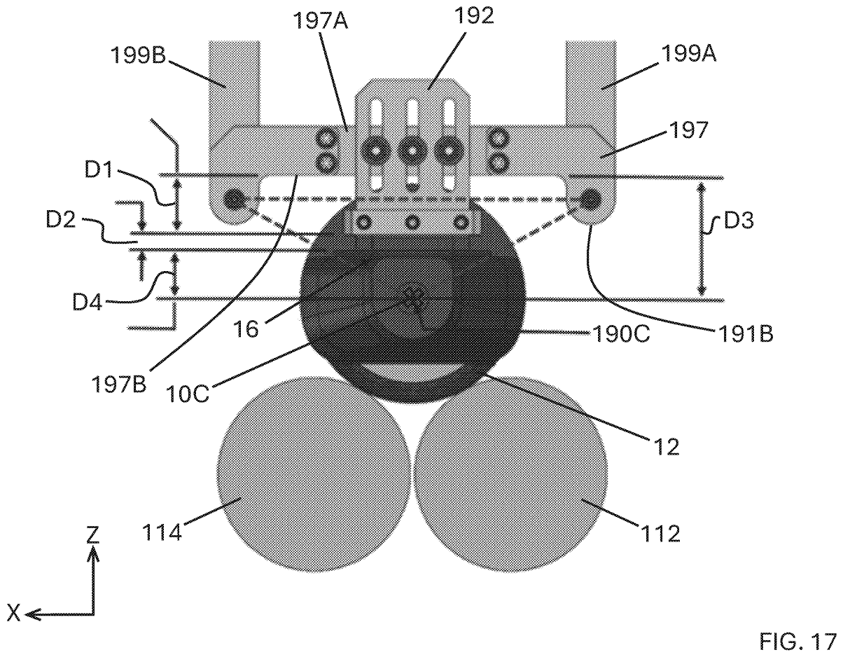

As may be more readily understood with reference to FIG. 16 and FIG. 17, the lower link 197 may be removably connected to the side links (199A, 199B), such that an orientation of the lower link 197 may be adjusted to suit different applications of the tilt actuator 190 and accommodate a variety of locations of the rider interface component 16 of the associated vehicle 10. Put another way, the main body 197A of the lower link 197 is positioned lower along the axis Z than the terminal ends of the side links 199A, 199B to which the lower link 197 is removably connected, such as is illustrated in FIG. 16, and the lower link 197 can, in examples, be inverted along the axis Z and oriented such that the main body 197A of the lower link 197 is positioned higher along the axis Z than the terminal ends of the side links 199A, 199B to which the lower link 197 is removably connected, such as is illustrated in FIGS. 14, 15, and 17. By way of non-limiting example, in the illustrative example of FIG. 16, the interface member 192 of the tilt actuator 190 can be particularly adapted to interface with a rider interface component 16 (e.g., a footpad) of the associated vehicle that is positioned at or below the true center of rotation 10C of the wheel 12 of the associated vehicle 10 by positioning the lower link 197 of the parallelogram linkage 191 to which the interface member 192 is attached in an orientation in which the main body 197A of the lower link 197 defines the lower end 191B of the parallelogram linkage 191 (e.g., the main body 197A of the lower link 197 is positioned lower along the axis Z than the terminal ends of the side links 199A, 199B to which the lower link 197 is removably connected). In this way, the interface member 192 can interface with the rider interaction component 16 of the associated vehicle 10 that is positioned at or below the true center of rotation 10C of the wheel 12 of the associated vehicle 10 to align the virtual pivot point 190C created by the tilt actuator 190 with the true center of rotation 10C of the wheel 12 of the associated vehicle 10. By way of further non-limiting example, in the illustrative example of FIG. 17, the interface member 192 of the tilt actuator 190 can be particularly adapted to interface with a rider interface component 16 (e.g., a footpad) of the associated vehicle that is positioned at or above the true center of rotation 10C of the wheel 12 of the associated vehicle 10 by positioning the lower link 197 of the parallelogram linkage 191 to which the interface member 192 is attached in an orientation in which the main body 197A of the lower link 197 is spaced apart from and does not define the lower end 191B of the parallelogram linkage 191 (e.g., the main body 197A of the lower link 197 is positioned higher along the axis Z than the terminal ends of the side links 199A, 199B to which the lower link 197 is removably connected, such that the terminal ends of the side links 199A, 199B define the lower end 191B of the parallelogram linkage 191). In this way, the interface member 192 can interface with the rider interaction component 16 of the associated vehicle 10 that is positioned at or above the true center of rotation 10C of the wheel 12 of the associated vehicle 10 to align the virtual pivot point 190C created by the tilt actuator 190 with the true center of rotation 10C of the wheel 12 of the associated vehicle 10.

As may be more readily understood with reference to FIG. 16 and FIG. 17, to align the virtual pivot point 190C created by the tilt actuator 190 with the true center of rotation 10C of the wheel 12 of the associated vehicle 10, a distance D4 between the axis of rotation of the associated vehicle 10 (e.g., the true center of rotation 10C) and a terminal edge of the rider interface component 16 of the associated vehicle 10 (e.g., a top surface of a footpad) can be determined (e.g., measured), and an offset D1 can be determined (e.g., calculated), such that the interface member 192 of the tilt actuator 190 can be selectively adjusted and positioned at an appropriate position for aligning the virtual pivot point 190C created by the tilt actuator 190 with the true center of rotation 10C of the wheel 12 of the associated vehicle 10.

When the rider interface component 16 of the associated vehicle 10 is positioned at or below the true center of rotation 10C of the wheel 12 of the associated vehicle 10 (refer to FIG. 16), the offset D1 can be calculated according to the following equation:

D1=D3+D4−D2
where:
D1 is the offset between the lower terminal edge 197B of the main body 197A of the lower link 197 (in this case defining the lower end 191B of the parallelogram linkage 191, as described herein) and an end of the interface member 192 to which the compliant surface 192A is connected;
D2 is a thickness of the complaint surface 192a (e.g., rubber pad) of the interface member 192;
D3 is a distance between the lower terminal edge 197B of the main body 197A of the lower link 197 (in this case defining the lower end 191B of the parallelogram linkage 191, as described herein) and the true center of rotation 10C of the wheel 12 of the associated vehicle 10; and
D4 is the distance between the axis of rotation of the associated vehicle 10 (e.g., the true center of rotation 10C of the wheel 12 of the associated vehicle 10) and the rider interface component 16 of the associated vehicle 10 (e.g., an upper terminal edge thereof, such as a top surface of a footpad), which would be zero if the rider interface component 16 of the associated vehicle 10 is positioned at the true center of rotation 10C of the wheel 12 of the associated vehicle 10. It will be appreciated that, in many instances, the distance between the interface member 192 (e.g., a lower terminal edge thereof, such as defined by a bottom surface of the complaint surface 192A) and the rider interface component 16 (e.g., an upper terminal edge thereof, such as a top surface of a footpad) will be zero.

When the rider interface component 16 of the associated vehicle 10 is positioned at or above the true center of rotation 10C of the wheel 12 of the associated vehicle 10 (refer to FIG. 17), the offset D1 can be calculated according to the following equation:

D1=D3−D4−D2
where:
D1 is the offset between the lower terminal edge 197B of the main body 197A of the lower link 197 (in this case spaced apart from the lower end 191B of the parallelogram linkage 191, as described herein) and an end of the interface member 192 to which the compliant surface 192A is connected;
D2 is a thickness of the complaint surface 192A (e.g., rubber pad) of the interface member 192;
D3 is a distance between the lower terminal edge 197B of the main body 197A of the lower link 197 (in this case spaced apart from the lower end 191B of the parallelogram linkage 191, as described herein) and the true center of rotation 10C of the wheel 12 of the associated vehicle 10; and
D4 is the distance between the axis of rotation of the associated vehicle 10 (e.g., the true center of rotation 10C of the wheel 12 of the associated vehicle 10) and the rider interface component 16 of the associated vehicle 10 (e.g., an upper terminal edge thereof, such as a top surface of a footpad), which would be zero if the rider interface component 16 of the associated vehicle 10 is positioned at the true center of rotation 10C of the wheel 12 of the associated vehicle 10. As will be appreciated, in many instances, the distance between the interface member 192 (e.g., a lower terminal edge thereof, such as defined by a bottom surface of the complaint surface 192A) and the rider interface component 16 (e.g., an upper terminal edge thereof, such as a top surface of a footpad) will be zero.

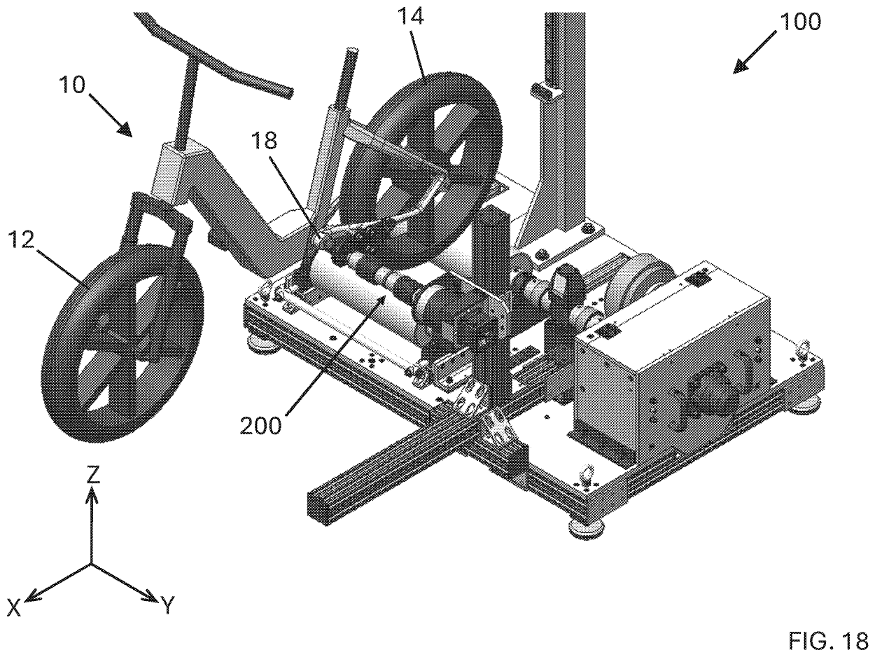

With reference now to FIG. 18, the dynamometer 100 is shown according to an illustrative example of the present disclosure in which the dynamometer 100 includes a pedal control assembly 200. The pedal control assembly 200 is generally configured to interface with (e.g., connect to and operate) a pedal component 18 (e.g., pedal, pedal crank arm) or similar component of the associated vehicle 10 to impart a pedaling input thereto, such as to simulate a rider's foot applying pedal input or motion.

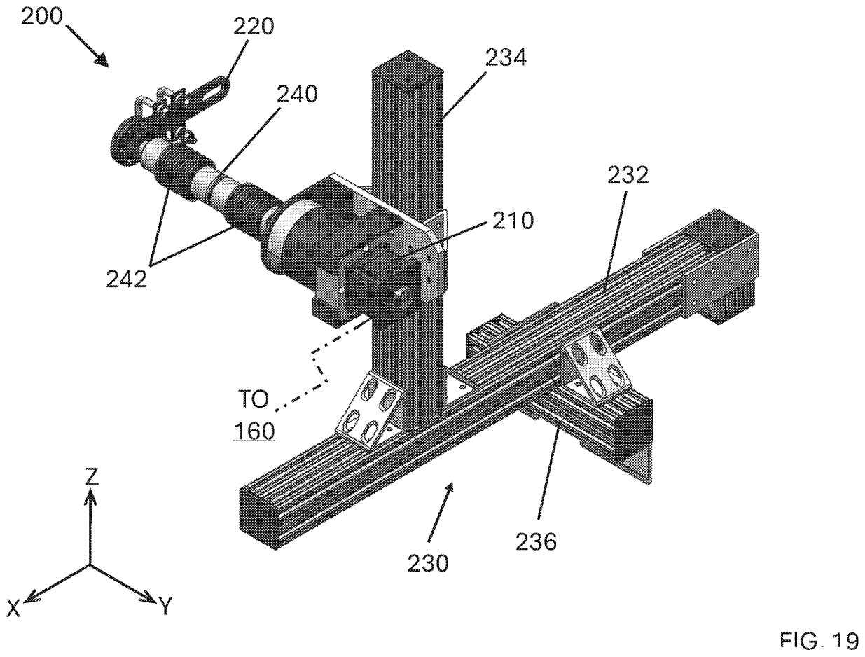

In the illustrative example of FIG. 19, the pedal control assembly 200 includes a motor 210 and a crank arm 220 operatively connected to the motor 210. The motor 210 and the crank arm 220 can generally be sized, shaped, constructed, and configured as desired to suit a particular application. The pedal control assembly 200 can, in examples, include a drive spindle 240 extending between and interconnecting the motor 210 and the crank arm 220. The crank arm 220 can thereby transmit pedal motion (e.g., torque) from the motor 210 to the pedal component 18 of the associated vehicle 10.

In examples, the pedal control assembly 200 can include a frame 230. The frame 230 can generally be configured to distribute reactionary torque from the pedal control assembly 200 to the frame 230. In specific examples, the frame 230 can include one or more frame members. In the illustrative example of FIG. 19, the frame 230 includes a first frame member 232 elongated along the axis X, a second frame member 234 attached to the first frame member 232 and extending upwardly away from the first frame member 232 along the axis Z substantially perpendicular to the axis X, and a third frame member 236 attached to the first frame member 232 and elongated along the axis Y substantially perpendicular to the axis X. The pedal control assembly 200 is operatively connected (e.g., directly) to the second frame member 234 in such a way that the pedal control assembly 200 can be adjustable along the axis Z and/or the axis Y and/or the axis X.

In examples, the drive spindle 240 of the pedal control assembly 200 can include one or more joints 242 (e.g., flexible couplings, universal joints), such as to interconnect various portions of the drive spindle 240 between the motor 210 and the crank arm 220. In the illustrative example of FIG. 19, the drive spindle 240 includes two joints 242 spaced apart from one another along the drive spindle 240. Each joint 242 is generally configured to provide at least one axis of misalignment between the motor 210 and the drive spindle 240. The foregoing, in conjunction with the adjustability of the pedal control assembly 200 as described herein, allows the pedal control assembly 200 to be used with a variety of different vehicles.

In specific examples, the pedal control assembly 200 (e.g., the motor 210 thereof) can be electronically controlled. For example, the motor 210 can be power-adjusted (e.g., by controller 160, via mechanical means, electronic means, pneumatic means, hydraulic means, or the like, including combinations thereof), such that the controller 160 may receive data (e.g., feedback) from the motor 210 and control operation of the motor 210, as described herein, responsive to such data. As will be appreciated, the motor 210 can be include and/or be implemented as a variety of components such as mechanical, electrical, electromechanical, and/or pneumatic components, including combinations thereof adapted to impart or produce motion for causing the crank arm 220 (e.g., via the drive spindle 240) to interface with (e.g., connect to and operate) and transmit pedal motion (e.g., torque) from the motor 210 to the pedal component 18 of the associated vehicle 10.

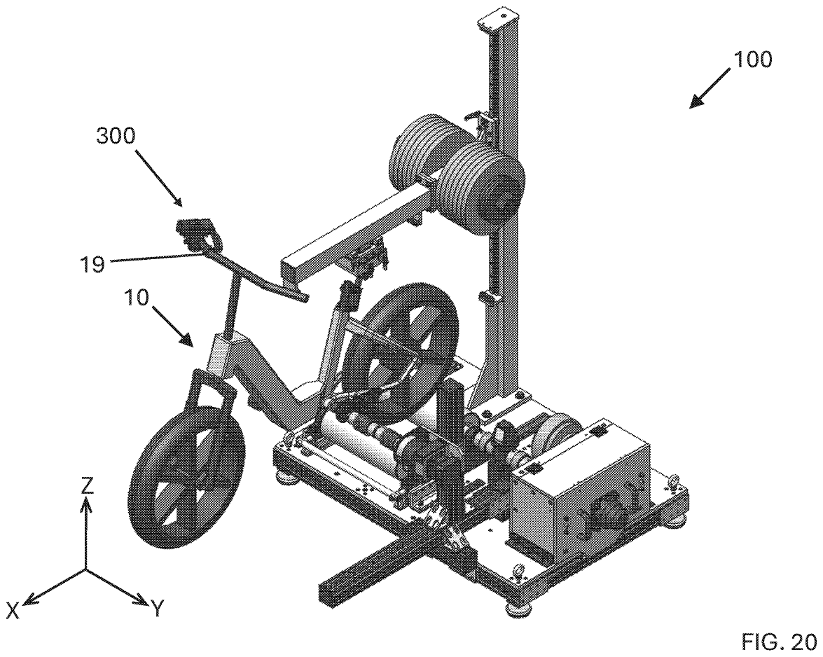

With reference now to FIG. 20, the dynamometer 100 is shown according to an illustrative example of the present disclosure in which the dynamometer 100 includes a throttle control assembly 300. The throttle control assembly 300 is generally configured to interface with (e.g., connect to and operate) a throttle mechanism 19 (e.g., a twist throttle) or similar component of the associated vehicle 10 to impart a throttling input thereto, such as to simulate a rider's thumb applying throttle input or force.

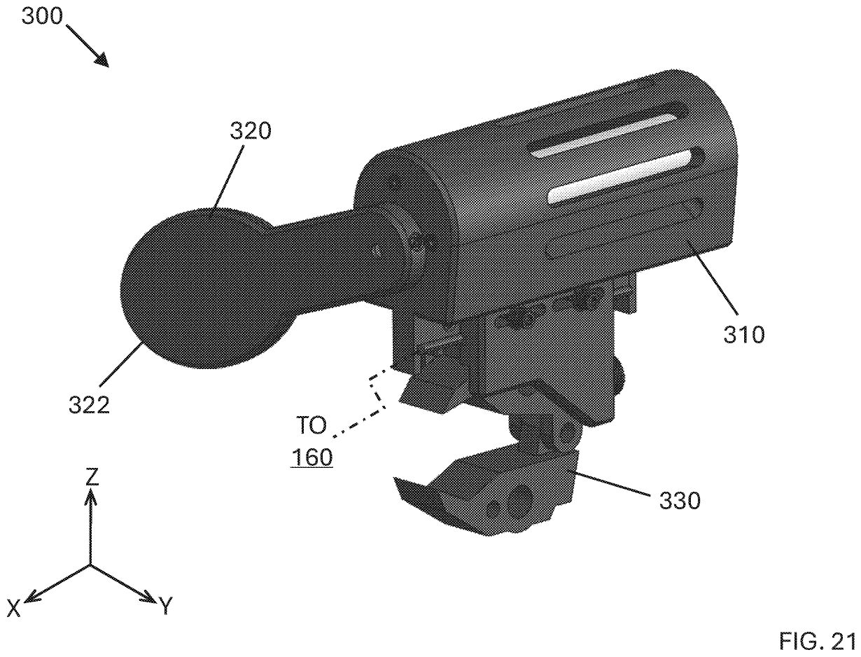

In the illustrative example of FIG. 21, the throttle control assembly 300 includes a motor 310 and an interface mechanism (e.g. a lever 320) operatively connected to the motor 310. The motor 310 and the lever 320 can generally be sized, shaped, constructed, and configured as desired to suit a particular application. The lever 320 can, in examples, be a paddle and/or can define a surface 322 configured to interface with the throttle mechanism 19 of the associated vehicle 10, such as by simulating a rider's thumb applying a force to the throttle mechanism 19. The lever 320 can thereby transmit throttle input (e.g., motion) from the motor 310 to the throttle mechanism 19 of the associated vehicle 10.

In examples, the throttle control assembly 300 can include an attachment mechanism 330. The attachment mechanism 330 can, in examples, be clamp or similar mechanism. The attachment mechanism 330 can generally be configured to removably attach the throttle control assembly 330 to the associated vehicle 10 (e.g., to a handlebar or other component of the associated vehicle 10), such as adjacent the throttle mechanism 19 of the associated vehicle 10 as illustrated in FIG. 20.

In specific examples, the throttle control assembly 300 (e.g., the motor 310 thereof) can be electronically controlled. For example, the motor 310 can be power-adjusted (e.g., by controller 160, via mechanical means, electronic means, pneumatic means, hydraulic means, or the like, including combinations thereof), such that the controller 160 may receive data (e.g., feedback) from the motor 310 and control operation of the motor 310, as described herein, responsive to such data. As will be appreciated, the motor 310 can be include and/or be implemented as a variety of components such as mechanical, electrical, electromechanical, and/or pneumatic components, including combinations thereof adapted to impart or produce motion for causing the lever 320 (e.g., the paddle 322 thereof) to interface with (e.g., connect to and operate) and transmit throttle input (e.g., motor) from the motor 310 to the throttle mechanism 19 of the associated vehicle 10.

In certain examples, the dynamometer 100 can include a platform 101 to which the components of the dynamometer 100 can be rigidly attached to provide structural support to the dynamometer 100 and/to absorb forces, although other examples are not so limited and the components of the dynamometer 100 can alternatively be rigidly attached to another structure (e.g., floor, ground). In examples in which a platform 101 is provided, the platform 101 can include one or more feet 101A for supporting the platform 101 and adjusting a height of the platform 101. In examples in which a platform 101 is provided, the roller assembly 110 (e.g., the rail(s) 116 thereof) can be attached (e.g., directly) to the platform 101 such that the roller(s) thereof are elongated along an axis Y, the flywheel assembly 120 can be attached (e.g., directly) to the platform 101, the vertical spar 170 can be attached (e.g., directly) to the platform 101 such that the vertical spar 170 extends upwardly along an axis Z away from the platform 101, and/or the frame 230 of the pedal control assembly 200 can be attached (e.g., directly) to the platform 101.

Having described several exemplary embodiments, it will be recognized by those skilled in the art that various modifications, alternative constructions, and equivalents may be used without departing from the spirit of the disclosure. Additionally, certain well-known processes and components may not have been described in order to avoid unnecessarily obscuring the disclosure. Accordingly, the above description should not be taken as limiting the scope of the disclosure.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the devices and systems, which, as a matter of language, might be said to fall therebetween. The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the examples described or illustrated herein that a person having ordinary skill in the art would comprehend. The scope of this disclosure is not limited to the examples described or illustrated herein. Moreover, although this disclosure describes and illustrates respective examples herein as including particular components, features, functionality, or characteristics, any of these examples may include any combination or permutation of any of the components, features, functionality, or characteristics described or illustrated anywhere herein that a person having ordinary skill in the art would comprehend.

Finally, the language used in the specification has been principally selected for readability and instructional purposes, and it may not have been selected to delineate or circumscribe the subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed is:

1. A modular dynamometer for use with an associated vehicle, the dynamometer comprising:
a roller assembly comprising at least one roller configured to interface with one or more corresponding wheels of the associated vehicle;
a flywheel assembly operatively connected to the roller assembly and configured to simulate an inertial load on the associated vehicle via the at least one roller of the roller assembly;
a brake operatively connected to the roller assembly and configured to simulate a parasitic load for the associated vehicle via the at least one roller of the roller assembly;
a drive shaft extending between and interconnecting the at least one roller of the roller assembly and the flywheel assembly; and
a sensor disposed between the roller assembly and the brake and operatively connected to the at least one roller of the roller assembly.

2. The dynamometer of claim 1, wherein the at least one roller comprises a main roller and an idler roller spaced apart from the main roller and configured to move relative to the main roller to adjust a spacing between the main roller and the idler roller.

3. The dynamometer of claim 1, further comprising a controller configured to receive data from the sensor and to operate the dynamometer responsive to the data from the sensor.

4. The dynamometer of claim 1, wherein a portion of the at least one roller defines an uneven surface.

5. The dynamometer of claim 1, further comprising a vehicle interface component configured to directly interface with a component of the associated vehicle to simulate a rider weight on the associated vehicle by applying a load to the component of the associated vehicle.

6. The dynamometer of claim 5, further comprising:
a vertical spar extending upwardly relative to the roller assembly along a first axis; and
a horizontal spar attached to and extending outwardly away from the vertical spar, the horizontal spar comprising a carriage, the vehicle interface component operatively connected to the carriage.

7. The dynamometer of claim 6, wherein the horizontal spar is defined by:
a proximal portion attached to and extending outwardly from the vertical spar; and
a distal portion attached to and extending outwardly from the proximal portion,
wherein the carriage is configured to slide along the distal portion to selectively position the carriage at a location corresponding to the component of the associated vehicle.

8. The dynamometer of claim 7, wherein at least one of the proximal portion of the horizontal spar and the distal portion of the horizontal spar defines a mechanical ballast loading location configured to receive one or more weight plates to simulate the rider weight on the associated vehicle.

9. The dynamometer of claim 6, further comprising a locking mechanism configured to be selectively moved between (a) an unlocked configuration in which the carriage is configured to freely slide along at least a portion of the horizontal spar along the second axis and (b) a locked configuration in which the carriage is prevented from sliding along at least the portion of the horizontal spar along the second axis.

10. The dynamometer of claim 6, wherein the vertical spar further comprises an actuator.

11. The dynamometer of claim 10, wherein the actuator is configured to be adjusted to apply the load to the component of the associated vehicle.

12. A modular dynamometer system for use with an associated vehicle, the system comprising:
a first modular dynamometer and a second modular dynamometer configured to be selectively positionable relative to one another, each of the first and second modular dynamometers comprising:
a roller assembly comprising at least one roller configured to interface with one or more corresponding wheels of the associated vehicle;
a flywheel assembly operatively connected to the roller assembly and configured to simulate an inertial load on the associated vehicle via the at least one roller of the roller assembly;
a brake operatively connected to the roller assembly and configured to simulate a parasitic load for the associated vehicle via the at least one roller of the roller assembly;
a drive shaft extending between and interconnecting the at least one roller of the roller assembly and the flywheel assembly; and
a sensor disposed between the roller assembly and the brake and operatively connected to the at least one roller of the roller assembly.

13. The system of claim 12, wherein the associated vehicle has a laterally-spaced wheel configuration and the first and second dynamometers are positioned side-by-side such that the roller assembly of the first dynamometer is configured to interface with one or more first side wheels of the associated vehicle and the roller assembly of the second dynamometer is configured to interface with one or more opposite second side wheels of the associated vehicle.

14. The system of claim 12, wherein the associated vehicle has a longitudinally-spaced wheel configuration and the first and second of dynamometers are positioned fore-aft of one another such that the roller assembly of the first dynamometer is configured to interface with one or more rear wheels of the associated vehicle and the roller assembly of the second dynamometer is configured to interface with one or more front wheels of the associated vehicle.

15. The system of claim 12, further comprising a third modular dynamometer and a fourth modular dynamometer configured to be selectively positionable relative to one another and relative to the first modular dynamometer and the second modular dynamometer, each of the third and fourth dynamometers comprising:
a roller assembly comprising at least one roller configured to interface with one or more corresponding wheels of the associated vehicle;
a flywheel assembly operatively connected to the roller assembly and configured to simulate an inertial load on the associated vehicle via the at least one roller of the roller assembly;
a brake operatively connected to the roller assembly and configured to simulate a parasitic load for the associated vehicle via the at least one roller of the roller assembly;
a drive shaft extending between and interconnecting the at least one roller of the roller assembly and the flywheel assembly; and
a sensor disposed between the roller assembly and the brake and operatively connected to the at least one roller of the roller assembly

16. A dynamometer for use with an associated vehicle, the dynamometer comprising:
a vehicle interface component configured to directly interface with a component of the associated vehicle, wherein the vehicle interface component comprises at least one of:
(a) a tilt actuator comprising an interface member configured to interface with a rider interaction component of the associated vehicle to align a virtual pivot point created by the tilt actuator with a true center of rotation of a wheel of the associated vehicle;
(b) a pedal control assembly comprising an interface member configured to interface with a pedal component of the associated vehicle to transmit pedal motion to the pedal component of the associated vehicle; and
(c) a throttle control assembly comprising an interface member configured to interface with a throttle mechanism of the associated vehicle to transmit throttle motion to the throttle mechanism of the associated vehicle.

17. The dynamometer of claim 16, further comprising a roller assembly comprising at least one roller configured to interface with one or more corresponding wheels of the associated vehicle.

18. The dynamometer of claim 16, wherein the vehicle interface component comprises the pedal control assembly, wherein the interface member of the pedal control assembly comprises a crank arm operatively connected to a motor.

19. The dynamometer of claim 18, wherein the vehicle interface component further comprises a drive spindle extending between the motor and the crank arm, the drive spindle comprising at least one joint configured to provide at least one axis of misalignment between the motor and the drive spindle.

20. The dynamometer of claim 16, wherein the vehicle interface component comprises the throttle control assembly, wherein the interface member of the throttle control assembly comprises an interface mechanism operatively connected to a motor.
